(19) United States
(12) Patent Application Publication
(10) Pub. No.: US 2017/0025031 A1
(43) Pub. Date: Jan. 26, 2017

(54) METHOD AND APPARATUS FOR TESTING A DEVICE FOR USE IN AN AIRCRAFT

(71) Applicant: Airbus Defence and Space GmbH, Taufkirchen (DE)

(72) Inventors: Daniel DREYER, Hohenkammer (DE); Matthias Oberhauser, Munchen (DE)

(21) Appl. No.: 15/068,183

(22) Filed: Mar. 11, 2016

(30) Foreign Application Priority Data
Mar. 13, 2015 (DE) 10 2015 103 735.1

(51) Int. Cl. G09B 9/30; G06F 3/01

(52) U.S. Cl. CPC G09B 9/302; G06F 3/011; G06F 3/016; G06F 3/04883

(57) ABSTRACT

In order to be able to test man-machine interfaces (74) cost-effectively under as realistic conditions as possible at as early a stage as possible, a method for testing at least one device (56) to be operated in aircraft by means of a virtual reality environment, wherein the at least one device (56) to be tested is represented in a virtual manner to a test subject (20), and an interaction between the test subject (20) and the at least one device (56) is recorded by means of or in the virtual reality environment.

The invention relates to a method for testing at least one device to be operated in aircraft. Furthermore, the invention relates to a device testing apparatus with which such a testing method can be carried out.

Highly modern aircraft, such as airplanes and helicopters, have ever more functions and complex systems. Nevertheless, they are supposed to be as easily controllable by pilots as possible. Therefore, cockpits, control stations and other man-machine interfaces for operating aircraft are to be developed further in such a way that the operation even of very complex flying apparatus becomes easier and less stressful for the crew members. In situations that necessitate human intervention, the crew members are thus better able to focus on the tasks required at that time.

Modern cockpits that combine functions and can be operated more intuitively have already been developed with respect to the controllability of aircraft with very different technical systems. Analog displays are replaced more and more by displays that can be shown on a screen so as to match the respective situation. There is a need for controlling different functions via finger control or gesture control, for example on tablet PC-like operating devices or on touchscreens. The developers always strive to develop optimum operator interfaces for this purpose, which do not make operation more difficult for the pilots, but easier.

There is a need for testing new operating concepts, which are realized, for example, by means of new operator interfaces, newly developed touchscreens or newly developed tablet PCs or graphic user interfaces, as realistically as possible and as extensively as possible.

The invention is based on the object of providing a method and an apparatus with which devices to be operated in an aircraft can be tested easily and cost-effectively, but nevertheless realistically, with respect to their suitability for operation in aircraft already in an early development phase.

This object is achieved by a method according to claim 1 and an apparatus according to the additional independent claim.

Advantageous embodiments of the invention are the subject matter of the dependent claims.

According to a first aspect, the invention provides a method for testing at least one device to be operated in aircraft by means of a virtual reality environment, wherein the at least one device to be tested is represented in a virtual manner to a test subject, and an interaction between the test subject and the at least one device is recorded by means of the virtual reality environment.

It is preferred that at least the test subject is moved by a motion platform in accordance with an operating situation of the aircraft to be simulated in the virtual reality environment.

It is preferred that the device is simulated by a dummy object for representing a haptic feedback.

It is preferred that the dummy object and the test subject are moved on the motion platform.

It is preferred that a touchscreen or a tablet PC with an operating function to be tested are haptically simulated by a panel surface on the dummy object, or that a touchscreen or a tablet PC with an operating function to be tested are attached to a retaining mechanism for operation by the test subject.

It is preferred that a user interface for controlling a function of the aircraft to be operated by a member of the cockpit crew is tested with the method.

It is preferred that a cockpit operating device to be newly developed is tested with the method.

It is preferred that a tablet PC or a touchscreen with an operator interface to be tested is tested with the method.

It is preferred that a user interface with gesture or finger control and a functional device to be tested, which is to be operated via the gesture or finger control, is tested with the method.

It is preferred that a device equipped with a display device for an operator is tested with the method.

It is preferred that a device to be operated by a member of the cabin crew is tested with the method.

It is preferred that a device to be used and/or operated by a passenger and/or cabin equipment to be used by a passenger is tested with the method.

It is preferred that a device equipped with a display device is tested and that the display device and/or depictions to be displayed on the display device are represented to the test subject in a virtual manner.

It is preferred that a dummy object for providing a haptic feedback is provided, which is not equipped with a display device. Alternatively, a retaining mechanism for the device and/or its display device is provided.

According to another aspect, the invention provides a device testing apparatus for testing devices to be operated in aircraft, comprising

a virtual reality system for generating a virtual reality environment
and a test subject station in which a test subject can stay for testing the device, so that the test subject is integrated into the virtual reality environment,
wherein the virtual reality system is configured for representing the device to be tested to the test subject in a virtual manner, and
wherein the virtual reality system is configured for recording interactions between the test subject and the device to be tested.

It is preferred that the test subject station is formed on a motion platform and that the virtual reality system is configured to move the motion platform in accordance with an operating situation of the aircraft to be simulated by means of the virtual reality environment.

It is preferred that a dummy object is provided for the device to be represented in a virtual manner in order to provide the test subject with a haptic feedback during testing. Alternatively, a retaining mechanism for the device to be tested is provided in order to provide the test subject with a haptic and/or functional feedback directly on the device. The latter option is of interest particularly with regard to testing a touchscreen or a user interface with finger or gesture control and new operator interfaces to be tested or new functional capabilities to be tested.

It is preferred that the dummy object is disposed on the motion platform.

It is preferred that the dummy object has a panel for haptically simulating a tablet PC or touchscreen to be tested.

It is preferred that the virtual reality system is configured for representing to the test subject, in a virtual manner, a display device of a device to be tested.

According to a particularly preferred embodiment of the method and the apparatus, a virtual reality flight simulation with a motion platform is provided.

Thus, devices to be newly developed can be tested realistically in a relatively cost-effective manner. In particular, a motion feedback, a force feedback and/or a vibration feedback can thus be provided in virtual reality environments so that devices to be tested, which can be represented in a virtual manner in the virtual reality environment, can be tested with regard to their operability in different flight situations or other operating situations of the aircraft. Thus, a flight experience that is as realistic as possible is generated in a virtual reality environment.

According to one idea, a movement is added to a method and an apparatus for carrying out research and development work with respect to new devices and concepts for aviation by means of virtual reality systems.

Special embodiments relate to concepts for motion-based cabin user studies and flight deck or cockpit user studies in a virtual reality environment.

The development process for flight decks and cockpit requires the integration of users and the research of the usefulness of man-machine interfaces at an early development stage in order to prevent misdevelopments. Thus, changes based on a feedback from user studies can be integrated into the product early on, and additional costs can be avoided. A prototype with a high level of simulation is advantageous for conducting such user studies. It would, of course, also be possible to form the respective product as realistically as possible as a prototype and then have it tested by a test subject as a user. However, such prototypes, which are realized using only hardware, are expensive and rather inflexible. In contrast, according to exemplary embodiments of the invention presented herein, it is proposed to use a cost-effective virtual reality flight simulator and/or a cost-effective virtual reality system for conducting such experiments.

In the previously examined virtual reality systems, however, concessions must be made with respect to the testability under real conditions, which are based on the functional capabilities of previous virtual reality systems and the virtual reality environment that can be generated by them.

One of these limitations is the lack of forces that arise during real flight operation. Accordingly, a virtual reality flight simulator that is extended with a useful and cost-effective motion system is presented in a preferred embodiment of the invention. Although flight simulators are well known, and small-scale motion platforms are also well known, they have so far not been used for realistic testing of operating devices during their development in virtual reality environments.

Such a combination can not only be used for carrying out user studies for new flight deck concepts, and in particular new operating concepts for aircraft cockpits, but may also be used for research related to passenger comfort in the cabin.

The invention will be explained in more detail below with reference to the attached drawings. In the drawings:

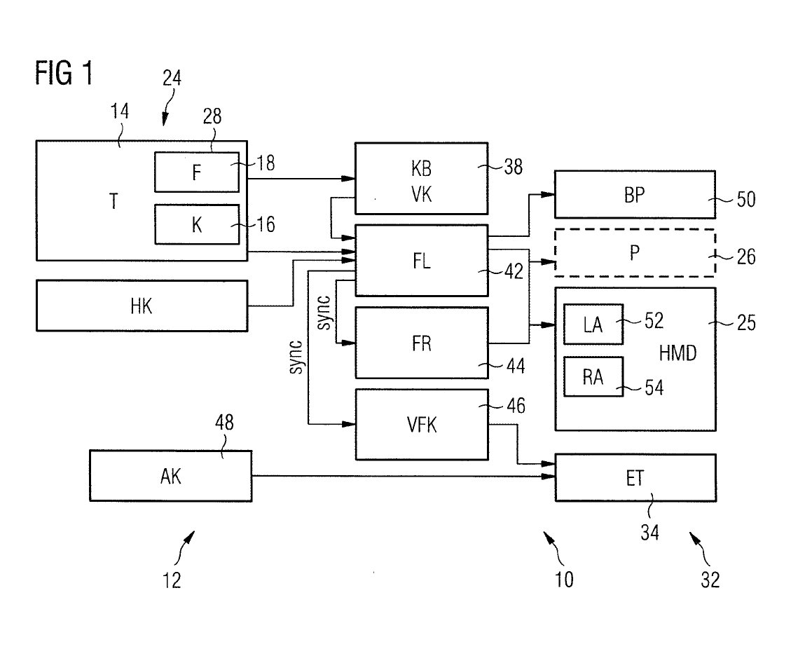

FIG. 1 shows a schematic block diagram of a virtual reality system for use in a testing method for testing devices for aircraft or for use in a device testing apparatus for testing aircraft;

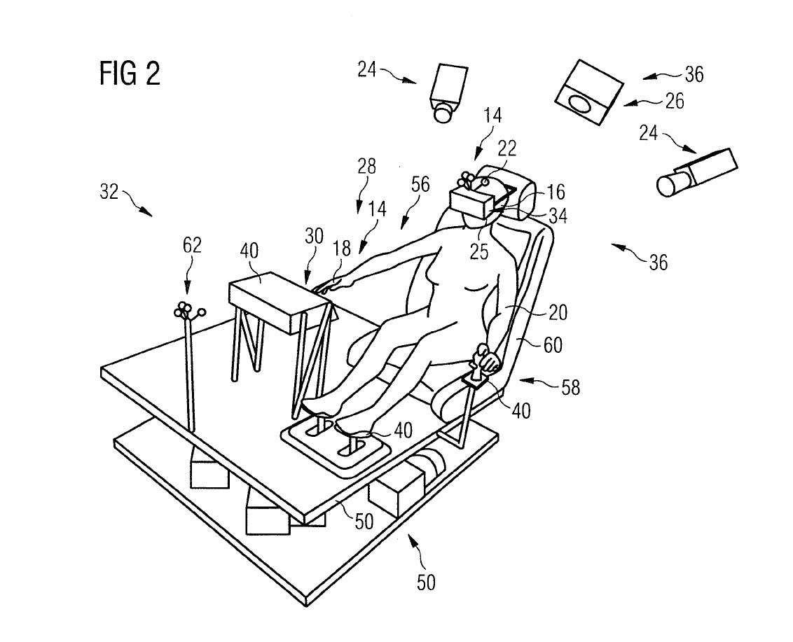

FIG. 2 shows a perspective schematic representation of an embodiment of the device testing apparatus using the virtual reality system from FIG. 1;

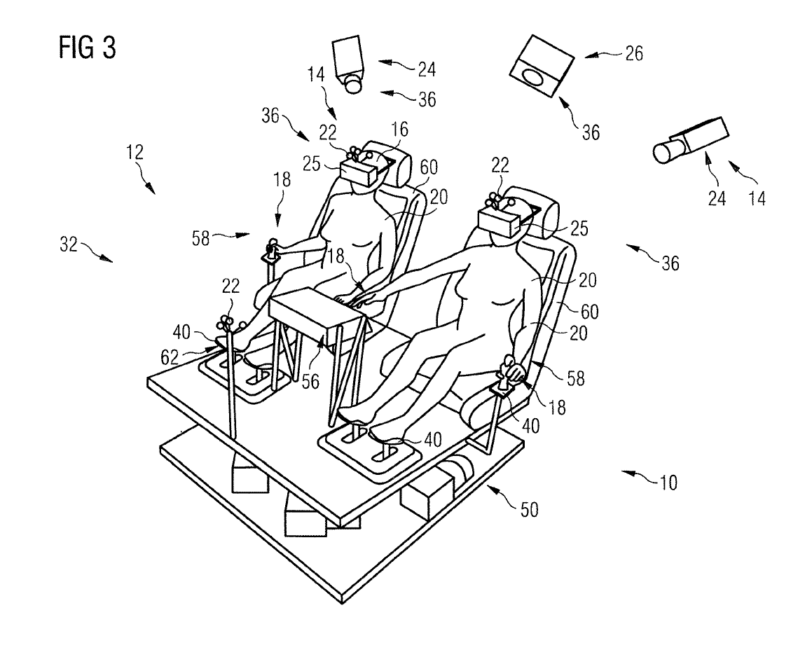

FIG. 3 shows another embodiment of the device testing apparatus;

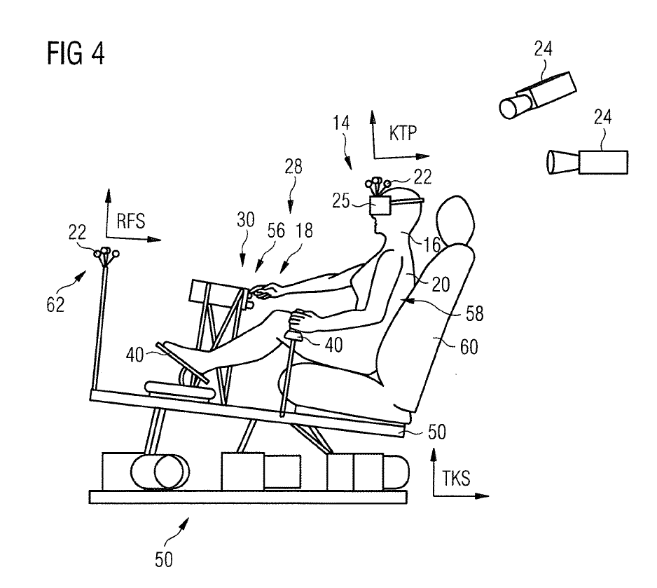

FIG. 4 shows a schematic side view of the device testing apparatus and its practical use in a testing method;

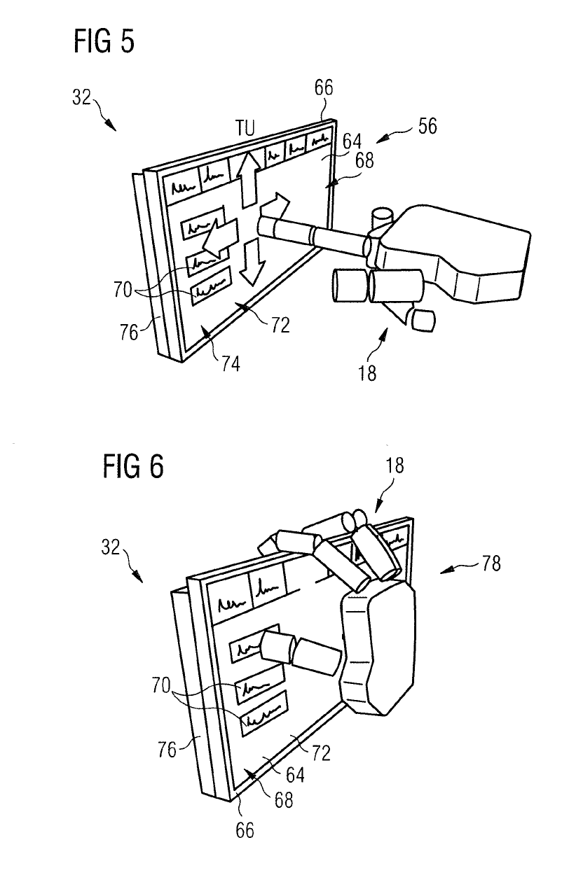

FIG. 5 shows a perspective view of an example of a device to be tested, which is to be tested with the device testing apparatus according to one of the FIGS. 2 to 3, during a flight situation in which turbulences occur and which is simulated by the device testing apparatus;

FIG. 6 shows an improved operating situation, which has arisen from the situation of FIG. 5, of the device to be tested during testing by means of the virtual reality environment generated by the virtual reality system of FIG. 1;

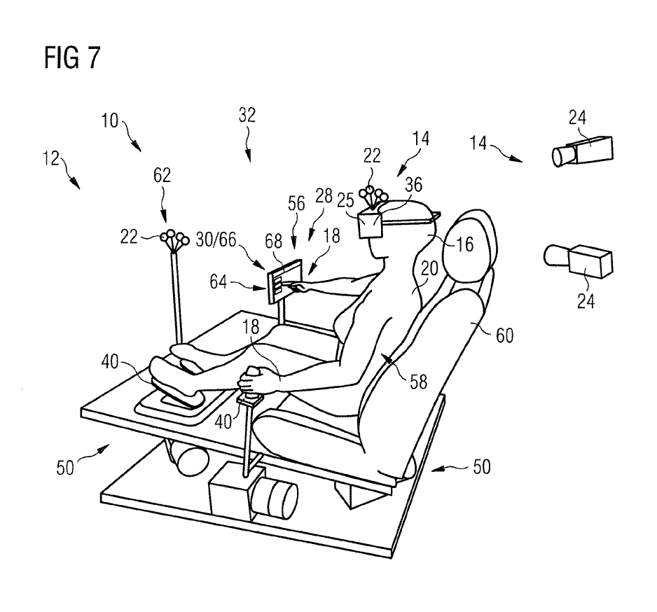

FIG. 7 shows a lateral view of the device testing apparatus while testing the device to be tested, which is shown in FIG. 5 and FIG. 6; and

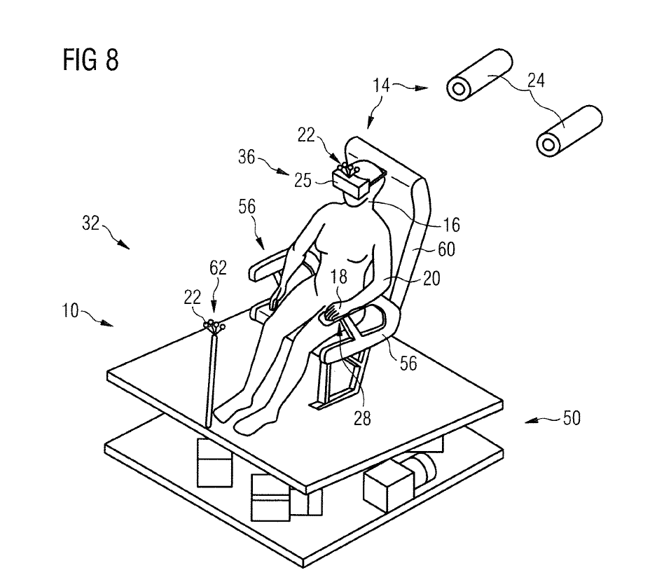

FIG. 8 shows the device testing apparatus while testing cabin equipment intended for the passenger in the aircraft cabin.

Hereinafter, exemplary embodiments of a method for testing devices 56 to be operated on aircraft and a device testing apparatus 32 for carrying out such a testing method are explained in more detail with reference to FIGS. 1 to 8.

The method and the apparatus 32 are particularly suitable for testing new operating concepts for cockpits of aircraft, such as airplanes or helicopters, particularly early in their development, in order to test with as little expenditure and testing effort as possible the feasibility and, in particular, the handling properties of the devices 56 by operating personnel at an early development stage. In particular, the human factor and the possibilities of the communication between man and machine—the “human factor”—are to be tested at an early stage without having to carry out more complex simulations or flight tests for testing the basic concept.

A virtual reality system 10 for representing a virtual reality environment is used in the method and the apparatus. In the configuration of the virtual reality system 10, use is made of flight simulations from the consumer sector, for example.

Carrying out human factor experiments using flight simulations from the consumer sector is an efficient research alternative to a complete physical mock-up due to the enormous realism. This realism is produced by a detailed visual design of the airplanes or other aircraft and their good flight properties.

According to one embodiment, cockpits modeled on the original are displayed in a virtual manner. These cockpits modeled on the original afford good conditions for carrying out human factor experiments, both in the field of basic research as well as of applied research. It is possible to extend the flight simulations in a modular manner. Software modules enable the integration of psychological measuring instruments into the simulation and the design of standardized test procedures. Furthermore, it is possible to present the flight simulations from the consumer sector not only two-dimensionally, but also three-dimensionally. Adding hardware components 40 to the flight simulation, such as sticks, thrust levers and rudder pedals, can increase the level of realism. New cockpit systems or even entire cockpit concepts can be integrated into the flight simulation and evaluated by means of a test subject study.

Some flight simulations offered in the consumer sector, such as Microsoft Flight Simulator, FlightGear or X-Plane, for example, offer a sufficient extent of ecological validity as a testing environment.

Some of these inexpensive or even free flight simulations meet conditions that satisfy the scientific requirements of basic research or even of applied research in the area of the human factor. These requirements are airplane models with realistic flight dynamics, a good graphical representation of the cockpit, a complete and faithful functional capability and operability of, if possible, all aircraft systems, and the option of redesigning or extending existing airplane models with innovative cockpit systems and entire cockpit concepts in order to evaluate them.

The high quality of the flight simulation generally causes a high level of acceptance with licensed pilots and thus increases their willingness to participate in human factor experiments. This fact facilitates the organization of experiments because pilots are a rather small population.

From the viewpoint of human factor research, one characteristic stands out: The above-described flight simulations, using supplementary modules, offer the possibility of designing a testing environment that satisfies the requirements of the respective experiment. Thus, modules make it possible to use a certain psychological measuring instrument, to work on a certain research issue, or to obtain a sufficient level of ecological validity—i.e. a reasonable relationship between the costs and the test expenditure to the level of realism. There are modules both in the area of software as well as hardware. Software modules can serve for implementing new flight systems or innovative cockpit concepts, embedding psychological measuring instruments or designing standardized flight tasks. Hardware components 40, e.g. in the form of operating members, enhance the level of realism in the area of haptics. Tracking systems 14, 28, 34 link the body movements of the test subjects 20 to the image area and thus improve the spatial perception of the cockpit. In addition, they provide information on the movements and viewing directions of the test subjects 20 in the cockpit.

The basis for the virtual reality system 10 can be presumed to be flight simulations that were developed for the consumer sector. Due to their ease of operation and great variability with regard to flight conditions (weather, time of day, atmospherics etc.), the flight situation (altitude, attitude etc.) and the cockpit configuration (simulated aircraft systems, field of vision of the pilot, operating members etc.), they are suitable for a wide field of application. A high degree of practicability, a simple menu structure and, moreover, the low acquisition costs facilitate the first steps in using such a flight simulation for research purposes.

The modular extensibility of flight simulations from the consumer sector by means of software and hardware will be explained below. Options for the integration of psychological methods, a plug-in for designing standardized test procedures and various visualization options will be described.

The virtual reality system 10 has, in particular, at least one data processing unit (not shown) equipped for carrying out a flight simulation, one or several recording devices 24 that record the test subject 20 or parts of the test subject 20—particularly hands, fingers 18 or limbs, or limbs that are to be used for operating the device 56 to be tested—and a test subject accommodation station 58, where the test subject 20 can stay during the test. For example, the test subject accommodating station 58 may have a seat 60 for a crew member—e.g. a pilot's seat—or a standing space for the test subject 20, depending on the operating situation of the device 56 to be tested.

For example, a computer on which a flight simulation software runs—e.g. based on a flight simulator from the consumer sector—is provided as the data processing unit.

A fundamental function of any flight simulator is generating an exterior view. For this purpose, the terrain, objects and weather phenomena are represented three-dimensionally in a more or less realistic manner. In addition to the three-dimensional exterior view, a cockpit with instruments can be displayed for flight guidance.

The simplest case for displaying a cockpit in a flight simulator is the superposition of two-dimensional instruments over the exterior view of the pilot. This type of presentation puts the instruments (dynamic round instruments or displays) into the foreground. The cockpit geometry itself can only be suggested by two-dimensional graphics. Most frequently, only the most important instruments for the flight are provided in this representation, often only in a simplified form, due to lack of space. Other instruments or exterior views can be shown on separate monitors in order to work around this issue of lack of space.

Furthermore, all current flight simulators offer the possibility of using 3D geometry for visualizing the cockpit. As is customary in the field of computer games, these so-called virtual cockpits consist of so-called polygon meshes, a grid made up from triangles. Many commercially available Computer Aided Design (CAD) programs have the innate capability to export such a grid model. Therefore, a cockpit generated with a CAD program can be transferred to a flight simulator with relatively little trouble. In addition, this cockpit geometry can be provided with textures.

The realism of the representation in this case covers a range from a simplified, non-textured cockpit geometry to a detailed and accurate design with already pre-shaded textures or real photographs. Finished virtual cockpits are already available for many commercial types of airplane. The camera position can be changed in any way, and thus, different areas of the cockpit can be viewed and used as required during the flight.

In addition, due to the spread of modern, high-performance graphic boards, it is possible to generate dynamic shadows within the cockpit which additionally enhances the realistic impression during the simulation/flight.

However, the above-described virtual cockpits most frequently offer more than merely a three-dimensional representation. Rather, it is possible to incorporate dynamic textures and animated objects. Both the dynamic textures and the animations can in this case be tied to real time system parameters.

Thus, displays or dynamic round instruments can be integrated. In addition, levers or switches can be moved dynamically due to the animation of 3D objects. In addition to this simple application, animations also make it possible to activate or deactivate entire instruments during the simulation, or to change the position of elements in the cockpit during simulation.

These cockpits, which can also be dynamically modified to a certain extent, offer an enormous advantage over real, physical cockpit structures. For the latter, the effort for construction and modification is many times greater than in the case of purely virtual cockpits. In them, elements of the cockpit or the entire environment can thus be changed without much trouble. Comparative evaluations between two cockpit concepts or parts thereof can be carried out without any lengthy modifications. Within a short period of time, test subjects 20 are able to test different cockpits. Especially when working with pilots as test subjects 20, this is a great advantage because the availability of commercial pilots is difficult to predict. It is difficult to interview the same pilot again for a follow-up test after a few days, because he will probably be on the other side of the earth. A concentration of experiments with different experimental variations on a single day using a virtual cockpit is thus very useful if a pilot is to assess several cockpit concepts and if effects related to his fitness on that day are to be minimized.

In one embodiment of the device testing apparatus discussed herein and of the testing method that can be carried out with it, the cockpit geometry or spatial arrangement of elements, in addition to a flight task and/or instruments, may be of importance for a study; therefore, it is advantageous if the corresponding cockpit structure is spatially represented. According to one idea, a dummy object 30 is provided for a new device 56 to be tested, in order to generate a haptic feedback. This will be explained in more detail later.

In order to avoid elaborate modifications of a physical mock-up of even of a full flight simulator, a virtual reality flight simulator (VRFS) (the simulator 12), whose schematic structure is shown in a block diagram in FIG. 1, is provided for the virtual reality system 10. Some exemplary embodiments of the hardware configuration are shown in FIGS. 2, 3 and 4.

The core of the simulator 12 is formed by an optical tracking system 14 that is able to accurately determine the position and orientation of the head 16 and the fingers 18 down to tenths of a millimeter. For example, several measuring probes 22 are attached to each of the head 16 and the fingers 18 of the test subject 20, which can be detected in a spatially resolving manner by means of a recording system with several recording devices 24—in particular a camera system with several cameras.

The information of this head tracking is synchronized with the camera position in the 3D cockpit of the simulation.

In order to obtain a three-dimensional depth impression of the virtual cockpit and the environment, two synchronized instances of the flight simulator 42, 44 are used, or a single instance with two perspectives (split screen). The only difference between these two video images is a slight lateral displacement and rotation of the camera position. Then, these two video images are transmitted to an output device 36.

A head-mounted display (HMD) 25 can be used as the output device 36. For example, the former has a helmet, whose position is detected by the tracking system 14, with two displays 52, 54, of which one each is located directly in front of an eye of the test subject 20. To the test subject 20, these displays do not offer any view of the room in which he is located.

The HMD 25 is advantageous in that the test subject 20 is able to turn into any direction without any limitation and still is able to look at the two displays 52, 54 directly. Thus, the entire virtual cockpit can be observed and a higher level of immersion, i.e. the extent of immersion in the virtual world, can be achieved. Additionally, stereoscopy, i.e. a depth impression, can be achieved by the video images generated in the two flight simulator instances 42, 44 and their transmission to the respective monitor.

Alternatively, the video signals can also be projected onto a screen of a corresponding size via a projector 26, whereby the field of vision of the test subject 20 is utilized in its entirety. A stereoscopic impression can be obtained by a 3D projector in conjunction with 3D glasses, whose position is also detected by the tracking system 14. Modern projector systems can be cascaded. That means that several projectors 26 can be combined in order to expand the projection surface. This makes an almost unlimited resolution possible. Furthermore, a representation that is accurate with regard to angels and sizes is possible by an exact calibration. A rather large field of vision can be covered by the screen being curved.

In order also to be able to record an interaction with the virtual cockpit and, in particular, with a device 56 to be tested that is to be disposed in it, a finger tracking system 28 may be provided. In this case, the position and orientation of the hand and of the individual fingers 18 are detected.

For this purpose, the test subject 20 in one exemplary embodiment wears a special glove or elements that are put on the fingers 18 in order to provide measuring probes 22. The data, i.e. the position and orientation of the fingers 18 and the hand, are transmitted to the simulator 12. A simplified geometry of the hand is generated with these data, so that the test subject 20 sees a virtual image of his hand in the flight simulation.

In the fully virtual case, switches or keys of the cockpit can be operated by a collision calculation—collision calculation unit 38—of the finger geometry and the key geometry. Since the test subject 20 does not receive any haptic feedback in this case, a simple resistance (e.g. by means of panels) or a non-functional physical mock-up—a dummy object 30—can be provided at the exact same position in space. A simple haptic impression can thus be provided with little effort.

A fully virtual cockpit offers maximum flexibility because alterations can be made purely by way of the software. However, a fully virtual cockpit has drawbacks with regard to operability, because a haptic feedback is lacking completely in this case. The more hardware is incorporated into the system, the better the operability becomes due to the additional haptics. However, this advantage has to be bought with higher costs and a lower level of flexibility. Thus, alterations in the system can no longer be made purely by way of the software. Rather, hardware components 40 have to be shifted or completely redesigned. It is therefore advisable to use hardware components 40 particularly for rotary switches or elements that are constantly used.

Therefore, in one exemplary embodiment of the virtual reality environment 10, commercially available USB devices are used for the joystick, the thrust lever quadrant and the rudder pedals, i.e. the most important input devices for flight control. For example, the flight control unit (FCU), which is used for the operation of the autopilot, can additionally be simulated by a functional mock-up. This guarantees a high level of flexibility and the required degree of operability. If the virtual reality is enhanced with more real hardware, this advantage disappears, and the costs also approach those of a complete mock-up.

One aspect in the testing of new devices is the detection of visual attention when operating the device. In one embodiment of a device testing apparatus 32 that uses the virtual reality system 10 for testing devices 56 to be developed, two options are available for this purpose. One is an eye tracking system 34 integrated into the head-mounted display 25, and another is a software-based solution—a software-based attention detection. Both will be presented below.

The virtual reality flight simulator 12 can be extended with the tracking system 32. For this purpose, an eye camera 48 is incorporated into the output device HMD 25. This is done by means of a modular plug-in system and a toothed ring, as is explained and illustrated in more detail in EP 2 821 839 A1. With them, the eye tracking as a component of a head-mounted display 25 can be adapted to the physiology of the respective test subject 20. Furthermore, a virtual field camera 46 is used. The image of the virtual field camera 46 and the image of the eye camera 48 are superposed, and the scanning path is thus detected. In a synchronized instance, additional information relevant to the eye tracking or information for test evaluation can be shown without them being visible to the test subject 20. The data of the eye tracking can be evaluated manually, semi-automatically or fully automatically during the test review process.

In contrast to the eye tracking, the software-based attention detection is a method for detecting visual attention integrated into the simulation as a plug-in. In the process, the test subject 20 is required to perform a main task and a second task in order to detect the distribution of visual attention.

The main task is, for example, controlling an aircraft. A pilot acting as the test subject 20 observes the displays and operates the input devices of the flight simulation as usual. The additional task is, for example, a detection task. Targets are shown in the cockpit window or at locations in the cockpit that are to be tested as to whether enough attention is paid to them. These targets are, for example, small squares and are shown in a randomized manner with regard to space and time. The task of the test subject consists of pressing a key as quickly as possible upon recognizing a target. In the cockpit, a key on the joystick or on the yoke is one option. The distribution of the visual attention is operationalized based on the detection rate of the targets in different areas of the cockpit. If reactions to targets are more frequent in a certain area than in other areas, then more visual attention is paid to the former area.

The above-mentioned techniques can be used for testing the operability and the usefulness of new devices 56.

The use of the device testing apparatus 32 for testing devices 56 for use in cockpits or other flight decks is explained in more detail below.

For this purpose, FIG. 1 shows the virtual reality flight simulator 12. A tested exemplary embodiment of the virtual reality flight simulator 12 extends a commercially available flight simulation software with virtual reality capabilities. Accordingly, virtual objects produced by means of corresponding CAD programs can be added to the software and virtually represented in this way in order to present them to a test subject 20 in the virtual reality environment.

A basic embodiment of the virtual reality system 10 has the tracking system 14, an output device 36 and the possibility of an interaction with the flight simulation and the digitally simulated device 56. For this purpose, an interaction between the test subject 20 and the device 56 to be tested is recorded by means of a recording device 24.

The tracking system 14 detects the measuring probes 22 on the head 16 and the fingers 18 of the test subject 20 and integrates them into the virtual reality environment of the flight simulation.

Virtual controls and devices to be operated can be presented purely virtually in a collision calculation unit 38.

In addition, a control stick, a thrust lever, a flight control unit (FCU) and other devices that are always common in cockpits are to be represented by hardware components 40 in order to provide the test subject 20 with a haptic feedback for these control devices that are usually provided in the cockpit.

As was already explained above, there is a first flight simulator 42 for the left eye and a second flight simulator 44 for the right eye that are synchronized with each other in such a way that a three-dimensional representation can be achieved, or an instance with a split screen is used. Further, a virtual field camera 46 is provided by means of which the surrounding area can be adapted to the viewing situation. An eye camera 48 detects the eyes of the test subject 20 and inputs the corresponding information into the eye tracking system 34.

Further, a motion platform 50 is provided which is moved based on the data from the flight simulators 12, 42, 44 in accordance with the flight situation to be tested.

The projector 26 and or the head-mounted display 25, which provides the left eye and the right eye with different representations 52, 54, can serve as the output device 36.

The configuration comprising the hardware components 40, the motion platform 50, the test subject 20, a device 56 to be tested, and a test subject accommodation station 58 on the motion platform 50, which has a seat 60 for the test subject 20, for example, are shown in various embodiments in FIGS. 2 to 4.

The optical tracking system 14 provides information about the six degrees of freedom for the head 16 of the test subject 20 and the position of his right hand and each of his fingers 18. These data are then transferred into the local coordinate system of the simulator 12. For detecting the local coordinate system, a reference measuring probe unit 62 with measuring probes 22, which serve as reference points for the local coordinate system, is provided on the motion platform 50.

The transformed hand tracking data generate a geometry in the virtual reality environment that simulates a human hand. The transformed head tracking data are linked to the virtual (field) camera 46 in the three-dimensional cockpit in the flight simulation in order to generate a realistic environment for the corresponding field of vision of the test subject 20. In order to generate a stereoscopic view, the head tracking data are transmitted to the two synchronized flight simulation instances 42, 44 of the simulator 12, with a corresponding optical transformation taking place for each eye.

The video data generated by the simulation or, in the case of the stereoscopic view, the two synchronized simulations, can be displayed to the test subject 20 by means of the head-mounted display 25. Examples for suitable HMDs 25 are the displays available on the market under the brand name NVIS SX 60 and “Sensics dSight”. For example, the HMD 25 has a resolution of 1280×1024 pixels per eye with a diagonal field of view (FOV) of 60 degrees. Another suitable HMD 25 provides 1920×1080 pixels per eye and a panoramic field of view of 131 degrees. In principle, however, any HMD that has a sufficiently high resolution is suitable.

Different methods have been designed and integrated into the simulator 12 in order to provide the test person 20 with control over the simulation and to interact with cockpit elements. The fully virtual representation of the interaction has also been examined. In this case, the device 56 to be tested is represented in a fully virtual manner and is not present in reality. A collision detection system—the collision calculation unit 38—is used in this case in order to detect a corresponding operation by the test subject 20, for example by means of the fingers 18, through a collision of the virtually generated fingers with the virtual device. If a collision between a virtual button geometry or the geometry of another operating unit and a virtual finger geometry is detected, a command signal is transmitted to the simulation. In such a case of a fully virtual control, the test subject 20 has no haptic feedback, which makes using such control elements difficult. An interaction with fully virtual elements can be improved with mechanisms for preventing multiple activation (debouncing filter) and by adapting the size of the collision volumes.

A simple haptic feedback can be generated already by arranging simple plywood panels or acrylic-glass panels or similar panels at the position in space of virtual buttons or other operating devices.

The usability of virtual elements can be additionally improved with this method of using dummy objects 30 for devices to be tested. Active hardware elements can also be tied in with the simulation. If these elements are placed at the exact same position in space as in the structure of the digital simulation, a so called “mixed mock-up” is produced. Frequently used levers and rotary knobs should be provided as hardware components 40 for a quick and intuitive utilization. Whether or not hardware devices that are actually operable are added to the structure of the digital simulation must be decided depending on the cost-benefit expenditure and depending on the desired flexibility.

In a particularly preferred embodiment of the device testing apparatus 32, an improved level of simulation is achieved by means of the motion platform 50, for a more realistic simulation of real flight conditions. G-stresses and g-forces are a substantial part of flying an aircraft because they are an indication, and sometimes the most essential and defining indication, of the behavior of the aircraft. Information about the current forces from the flight model is provided to the motion platform 50; the motion platform 50 translates this information into a corresponding movement of the platform. The motion platform 50 is not only capable of simulating forces, but also vibrations generated by turbulences or while rolling on an airfield.

There are small motion platforms 50 on the market already that are equipped for small-scale applications, such as end users, flight simulators or race simulators. These motion platforms 50 are moved by multiple electrical actuators, for example. Such motion platforms 50 are driven by the simulation data provided by the simulator 12 and provide motion in six degrees of freedom. In particular, the motion platform 50 is capable of moving along three axes and also of rotating about these axes. An inexpensive and compact motion platform 50 with six degrees of freedom is available, for example, under the brand name “CKAS 6DOF small scale motion platform”.

In preferred embodiments, motion platforms 50 are used that take up a surface area of less than 3 m×3 m, preferably less than 2 m×2 m, and have a weight of less than 1000 kg, preferably less than 500 kg.

The information about the position of the motion platform 50 is predetermined by the simulator 12.

FIGS. 2 to 8 show preferred possibilities for application of the motion platform 50 in a device testing apparatus 32. For this purpose, the hardware components 40 that are used for the simulation of a realistic test environment, as well as the device 56 to be tested and the seat 60, are mounted on the motion platform 50. Further, the reference measuring probe unit 62 is mounted on the motion platform 50 in order thus to move the coordinate system along correspondingly.

As shown in FIG. 3, another test subject accommodation station 58 in the form of another seat 60 for a second pilot or any other test subject 20 may also be added, depending on the size of the motion platform 50.

The tracking system 14 for tracking the position of the head 16 and the fingers 18 should record a tracking of the head 16 and the fingers 18 relative to the motion platform 50. That is why the reference target—the reference measuring probe unit 62—is mounted on the motion platform 50 in the exemplary embodiments shown, in which it is presumed that recording devices 24, such as several cameras, for example, have fixed positions in the testing space. If the tracking system 14—for example all recording devices 24 or cameras—are attached to the motion platform 50, such a reference target would not be absolutely necessary. In the case of acceleration sensors being used for tracking the head 16 and the fingers 18, the forces induced by the motion platform 50 should be subtracted from the force induced by the movement of the test subject 20.

A particularly preferred application of the device testing apparatus 32 and a method for testing a device for an aircraft is described below.

In the method, the virtual reality system 10 with the simulator 12 is used for generating a virtual reality environment. In the process, a geometry or a graphic of the device 56 to be tested in displayed in the virtual reality environment of the test subject 20.

As is apparent from FIG. 5, a touchscreen 64 or a tablet PC 66 with finger or gesture control is tested as the device 56 to be tested, for example.

In particular, an operator interface 72 with graphically represented buttons 70 or other user interfaces is shown on the display device 68 of the tablet PC 66—the former is, for example, configured as the touch screen 64—and it is tested whether the touchscreen 64, the tablet PC 66 and the user interfaces are suitable for operation in different flight situations.

With regard to the design of man-machine interfaces 74 in flight decks, the usefulness even in highly turbulent environments, in particular, should be examined. For instance, the usefulness of operator interfaces 72, their buttons 70, display devices 68 and/or tablet PCs, e.g. touchscreens 64, equipped with them are examined.

In particular, the motion platform 50 is used for this purpose in order to generate correspondingly turbulent conditions and test the operability of the device 56 to be tested, and in particular of its man-machine interface 74.

For this purpose, it is particularly advantageous if the test subject 20 receives a haptic feedback. As was already explained above, this can be achieved by means of a dummy object 30. For example, in order to simulate the haptic feedback of a touchscreen 64 or of a tablet PC 66, a simple panel, for example consisting of wood materials or plastics, is attached in the area of the test subject accommodation station 58.

In one embodiment, operator interfaces 72 of tablet PCs 66 can be generated by means of the virtual reality system 10 in a purely virtual manner on their display device 68 and virtually presented to the test subject 20 via the output device 36—e.g. HMD 25 or the projector 26.

Furthermore, however, a retaining mechanism 76 may be provided where a tablet PC 66 as the device 56 to be tested can be attached in reality. The tablet PC 66 or the other device 56 to be operated with the man-machine interface 74 to be tested can be connected to the virtual reality system 10 in order to test whether the correct commands can be inputted by the test subject 20.

As is apparent from the comparison of FIGS. 5 and 6, a test of a touchscreen 64 under highly turbulent conditions led to the insight that a certain handle 78 may help the pilot in certain situations. For example, FIG. 6 shows that several fingers 18 of the test subject 20 rest on the upper edge of the device 56 to be tested and that an operation of a button 70 can take place even under highly turbulent conditions, using the thumb. For example, this leads to the insight that, when integrating touchscreens 64, options for the pilot to rest his fingers should be provided in order to improve the operability of touchscreens 64.

Testing such devices 56 and, in particular, such man-machine interfaces 74 in a cost-effective virtual reality system 10 with a motion platform 50 may result in the further development of such devices 56, systems and man-machine interfaces 74. This applies not only to the research regarding touchscreens 64—even though the method is particularly preferred and suitable for this purpose—but also to any other hardware component 40 that can be integrated into the system.

As was already explained above, a touchscreen 64 can be added to the virtual reality environment by disposing the device 56 at exactly the same position as in the virtual world. This touchscreen 64 may be a functional touchscreen with the possibility of real operation as well as a non-functional dummy object 30 for generating a haptic feedback.

The corresponding complete situation is shown in FIG. 7.

Adding a motion platform 50 to a virtual reality flight simulator 12 increases the overall fidelity of the simulator 12 and thus the quality of user studies conducted with this system 10.

However, the test method and the device testing apparatus 32 are suitable not only for testing devices for flight decks. The virtual reality system 10 may also be used for conducting user studies regarding seat spacing, cabin interior design and even the acceptance of windowless cabins. With the virtual reality system 10 shown here, the influence of turbulences on passenger comfort, for example, may also be tested with a cost-effective test apparatus 32 having a simple structure. For example, seats, seat configurations, operating devices for operating seats or entertainment media etc. may be tested.

Another possible application is the testing of devices for the cabin crew. For example, kitchen appliances, communications devices or other devices to be operated by the cabin crew can be tested on a simple system under rather realistic simulation conditions at an early development stage.

The structure for testing cabin equipment as the device 52 to be tested requires less of an expenditure with regard to the virtual reality system and possible dummy objects 30 than testing cockpit devices. It is therefore not necessary to use a virtual reality flight simulator 12; a virtual reality system 10 without a flight simulation is sufficient. For example, a simple aircraft seat 60 and a reference target with a reference measuring probe unit 62 are sufficient. Since no exterior environment as a flight simulation is connected with such tests, the position of the motion platform 50 can simply be generated for recording by means of the recording devices 24.

### LIST OF REFERENCE NUMERALS

10 Virtual reality system
12 Simulator
14 Tracking system
16 Head
18 Finger
20 Test subject
22 Measuring probe
24 Recording device
25 Head-mounted display (HMD)
26 Projector
28 Finger tracking system
30 Dummy object
32 Device testing apparatus
34 Eye tracking system
36 Output device
38 Collision calculation unit
40 Hardware components
42 First flight simulator
44 Second flight simulator
46 Virtual field camera
48 Eye camera
50 Motion platform
52 View left eye
54 View right eye
56 Device to be tested
58 Test subject accommodation station
60 Seat
62 Reference measuring probe unit
64 Touchscreen
66 Tablet PC
68 Display device
70 Button
72 Operator interface
74 Man-machine interface
76 Retaining mechanism
78 Handle

### Labelling of the Blocks in FIG. 1:

Tracking
Finger
Head
HK Hardware components (Stick, thrust lever, FCU, . . . )
KB Collision calculation
VK Virtual monitoring
FL Flight simulator left eye
FR Flight simulator right eye
sync Synchronization
VFK Virtual field camera
AL Eye camera
ET Eye tracking
BP Motion platform
3D projector
HMD Head-mounted display
LA Left eye
RA Right eye

### Labelling FIG. 4:

KTP Head tracking position
TKS Tracking coordinate system
RFS Reference coordinate system

### Labelling FIG. 5:

TU Turbulences

1. A method for testing in a virtual reality environment at least one device to be operated in aircraft, wherein the at least one device to be tested is represented in a virtual manner to a test subject, and the method comprises recording an interaction between the test subject and the at least one device by means of or in the virtual reality environment.

2. The method according to claim 1, wherein at least the test subject is moved by a motion platform in accordance with an operating situation of the aircraft being simulated in the virtual reality environment.

3. The method according to claim 1, wherein the at least one device is simulated by a dummy object for representing a haptic feedback.

4. The method according to claim 2, wherein the dummy object and the test subject are moved on the motion platform.

5. The method according to claim 3, wherein a touchscreen or a tablet PC with an operating function to be tested are haptically simulated by a panel surface on the dummy object.

6. The method according to claim 1, wherein a touchscreen or a tablet PC with an operating function to be tested are attached to a retaining mechanism for operation by the test subject

7. The method according to claim 1, wherein the at least one device includes:
a) a user interface for controlling a function of the aircraft to be operated by a member of the cockpit crew,
b) a cockpit operating device to be newly developed,
c) a tablet PC or a touchscreen with an operator interface to be tested,
d) a user interface with gesture or finger control and a functional device to be tested, which is to be operated via the gesture or finger control,
e) a device equipped with a display device for an operator,
f) a device to be operated by a member of the cabin crew,
and/or
g) a device to be used and/or operated by a passenger.

8. The method according to claim 1 wherein the at least one device to be tested includes a display device equipped with a display device and that the display device and/or depictions to be displayed on the display device are represented to the test subject in a virtual manner.

9. A device testing apparatus for testing devices to be operated in aircraft, comprising
a virtual reality system configured to generate a virtual reality environment and a test subject station in which a test subject can stay for testing the device, so that the test subject is integrated into the virtual reality environment,
wherein the virtual reality system is configured for representing the device to be tested to the test subject in a virtual manner, and
wherein the virtual reality system is configured for recording interactions between the test subject and the device to be tested.

10. The device testing apparatus according to claim 9, wherein the test subject station is formed on a motion platform and that the virtual reality system is configured to move the motion platform in accordance with an operating situation of the aircraft to be simulated by means of the virtual reality environment.

11. The device testing apparatus according to claim 9, wherein a dummy object is provided for the device to be represented in a virtual manner in order to provide the test subject with a haptic feedback during testing.

12. The device testing apparatus according to claim 10 wherein the dummy object is disposed on the motion platform.

13. The device testing apparatus according to claim 11, wherein the dummy object has a panel for haptically simulating a tablet PC or touchscreen to be tested.

14. The device testing apparatus according to claim 9 wherein the virtual reality system is configured to represent the test subject, in a virtual manner, a display device of a device to be tested.
